(19) United States
(12) Patent Application Publication
(10) Pub. No.: US 2020/0270921 A1
(43) Pub. Date: Aug. 27, 2020

(54) CLICK IN CABINET HINGE

(71) Applicant: FATH, Inc., Orlando, FL (US)

(72) Inventors: Armin Fink, Ocoee, FL (US); Joseph Oliva, Orlando, FL (US)

(21) Appl. No.: 16/797,568

(22) Filed: Feb. 21, 2020

Related U.S. Application Data
(60) Provisional application No. 62/808,922, filed on Feb. 22, 2019.

(51) Int. Cl. E05D 7/10; E05D 3/02

(52) U.S. Cl. CPC E05D 7/1061; E05D 5/046; E05D 3/02

(57) ABSTRACT

An apparatus, having: a first hinge part (10) including: a first plate (11); a second plate (13) with two projections defining a recess therebetween; and a hinge pin (15) exposed in the recess between the two projections; and a second hinge part (20) including: a housing (21) with a u-shaped receiver (23) configured to partly fit between the two projections and to receive the hinge pin therein and enable the housing to rotate about the hinge pin. In a closed configuration when the first hinge part is secured to a cabinet (5) and to the second hinge part, and the second hinge part is assembled to a closed cabinet door (3), the closed cabinet door is disposed between the housing and the first plate and the u-shaped receiver opens forward and away from of the cabinet thereby trapping the closed cabinet door between the cabinet and the housing.

This application claims benefit of the Feb. 22, 2019 filing date of application 62/808,922 which is incorporated by reference herein.

### FIELD OF THE INVENTION

The present invention relates generally to hinge assemblies used on electronic cabinets or enclosures. More specifically, the invention relates to hinges that allow doors to both, be rotated about one of its sides in a traditional fashion and to be wholly detached from the cabinet or enclosure.

### BACKGROUND OF THE INVENTION

The explosive growth of data and information in recent years has led to a dramatic corresponding increase in the amount of data centers required to store all that information. Data center operators demand that the vast amounts of servers and equipment they rely on be protected by enclosures that not only organize the equipment but prevent unauthorized entry by individuals.

Additionally, data center operators see large cost reductions from being able to quickly and effectively access the equipment during and after installation. Therefore, significant benefits accrue from using cabinetry hardware like hinges and handles that allow security and ease of access to the equipment. By way of example, operators often require the hinges allow the doors to swing up to 180 degrees. Moreover, the ability to remove the doors without removing the hinges allows the operators to temporarily remove the doors while work is being performed and then replace the doors without complications. However, this is usually a two-person task. Another drawback is that most hinges that can be detached and reattached are orientation specific, i.e. they can only be used on the left or right side of the cabinet.

### SUMMARY OF THE INVENTION

Accordingly, the inventors have developed a click in cabinet hinge that allows installation and removal of the door by just one person. Upon installation, the part of the hinge mounted on the door is presented to the hinge pin mounted on the frame and upon applying pressure, a latch mounted on the door part of the hinge will retract enough to let the hinge pin through and then advance toward and over the hinge pin placing the catch attached to the latch around the hinge pin. For removal, the latch of each hinge is retracted to an open position and the door is removed. Moreover, the hinge is not orientation specific, i.e. it can be used on the left or the right-hand side of the door.

In an embodiment, the click in cabinet hinge includes: a first hinge part having: a first plate; a second plate with two projections protruding transverse to the first plate and defining a recess therebetween; and a hinge pin exposed in the recess between the two projections. The click in cabinet hinge further includes a second hinge part having: a housing with a u-shaped receiver configured to partly fit between the two projections and to receive the hinge pin therein and enable the housing to rotate about the hinge pin. In a closed configuration when the first hinge part is secured to a cabinet and to the second hinge part, and the second hinge part is assembled to a closed cabinet door, the closed cabinet door is disposed between the housing and the first plate and the u-shaped receiver opens forward and away from of the cabinet thereby trapping the closed cabinet door between the cabinet and the housing.

In an embodiment, the click in cabinet hinge includes a first hinge part having two projections defining a recess therebetween; and a hinge pin exposed in the recess between the two projections. The click in cabinet hinge further includes a second hinge part having: a housing defining a door side configured to be mounted to a cabinet door and a u-shaped receiver that faces away from the door side and that is configured to receive the hinge pin therein and enable the housing to rotate about the hinge pin. When in an assembled configuration, the first hinge part is secured to a cabinet and to the second hinge part and the second hinge part is assembled to the cabinet door, the door side rests on an outside-facing surface of the cabinet door.

In an embodiment, the click in cabinet hinge includes a first hinge part having two projections defining a recess therebetween; and a hinge pin exposed in the recess between the two projections. The click in cabinet hinge further includes a second hinge part having: a housing defining a door side configured to be mounted to a cabinet door and a u-shaped receiver that faces away from the door side and that is configured to receive the hinge pin therein and enable the housing to rotate about the hinge pin. In a closed configuration the first hinge part is assembled to a cabinet, the second hinge part is assembled to the first hinge part and to a closed cabinet door, and the hinge pin is disposed farther forward of the cabinet than a front face of the closed cabinet door.

### BRIEF DESCRIPTION OF THE DRAWINGS

These and other advantages of the invention will become more apparent from the following description in view of the drawings. Similar structures illustrated in more than one figure are numbered consistently among the drawings.

FIG. 1 is a perspective view of the click-in cabinet hinge installed on a door and frame where the door is partially closed, according to an embodiment of the present invention.

FIG. 2 is a perspective view of the click-in cabinet hinge installed on a door and frame where the door is partially closed similar to FIG. 1, according to an embodiment of the present invention.

FIG. 3 is a perspective view of the click-in cabinet hinge installed on a door and frame where the door is partially open, according to an embodiment of the present invention.

FIG. 4 is a partially exploded perspective view of the click-in cabinet hinge showing the exterior of the hinge, according to an embodiment of the present invention.

FIG. 5 is a partially exploded perspective view of the click-in cabinet hinge showing the inside of the hinge, according to an embodiment of the present invention.

FIG. 6 is a partially exploded plan view of the click-in cabinet hinge installed on a door and frame, where the door is partially open, according to an embodiment of the present invention.

FIG. 7 is a partially exploded side view of the click-in cabinet hinge installed on a door and frame where the door is partially open, according to an embodiment of the present invention.

FIG. 8A is a side view of the click-in cabinet hinge connecting a door to a frame when the door is in the closed position, according to an embodiment of the present invention.

FIG. 8B is a cross-sectional view of the click-in cabinet hinge, according to an embodiment.

FIG. 9A is a side view of the click-in cabinet hinge connecting a door to a frame when the door is in the closed position, according to an embodiment of the present invention.

FIG. 9B is a cross-sectional view of the click-in cabinet hinge, according to an embodiment.

FIG. 10A is a side view of the click-in cabinet hinge connecting a door to a frame when the door is in the closed position, according to an embodiment of the present invention.

FIG. 10B is a cross-sectional view off-set from the center of the click-in cabinet hinge, according to an embodiment.

### DETAILED DESCRIPTION OF THE INVENTION

The inventor of the present invention has developed a novel hinge that allows a door to be removed from a frame without having to remove the hinge from either the door or the frame.

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

It is important to an understanding of the present invention to note that all technical and scientific terms used herein, unless defined herein, are intended to have the same meaning as commonly understood by one of ordinary skill in the art. The techniques employed herein are also those that are known to one of ordinary skill in the art, unless stated otherwise. For purposes of more clearly facilitating an understanding of the invention as disclosed and claimed herein, the preceding definitions are provided. It is further noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced items.

As used herein, the term “tab” will be understood to mean any piece of material attached to or projecting from another piece of material capable of being used to hold or manipulate one or both pieces of material. Also as used herein, the term “biasing mechanism” will be understood to mean any piece of material capable of returning to its original shape after an applied force has been removed. As a non-limiting example, a “biasing mechanism” can be a spring such as a coil spring.

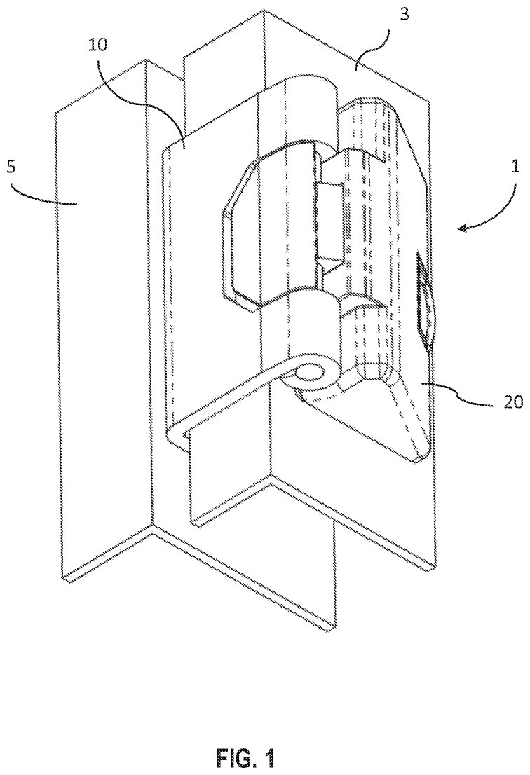

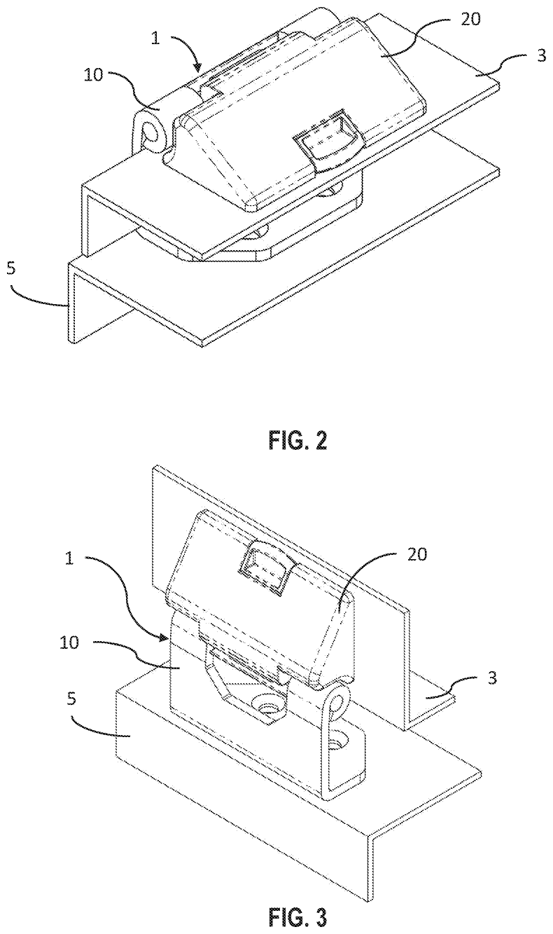

With respect to FIGS. 1 through 3, perspective views of the inventive click-in cabinet hinge 1 connecting a door 3 to a cabinet 5 (or frame thereof) is shown, according to an embodiment of the present invention. For clarity purposes the door 3 and cabinet 5 are shown only in relevant part. The click-in cabinet hinge 1 includes a first hinge part 10 and a second hinge part 20. FIG. 1 shows the click-in cabinet hinge 1 in a closed configuration. FIG. 3 shows the click-in cabinet hinge 1 in an open configuration.

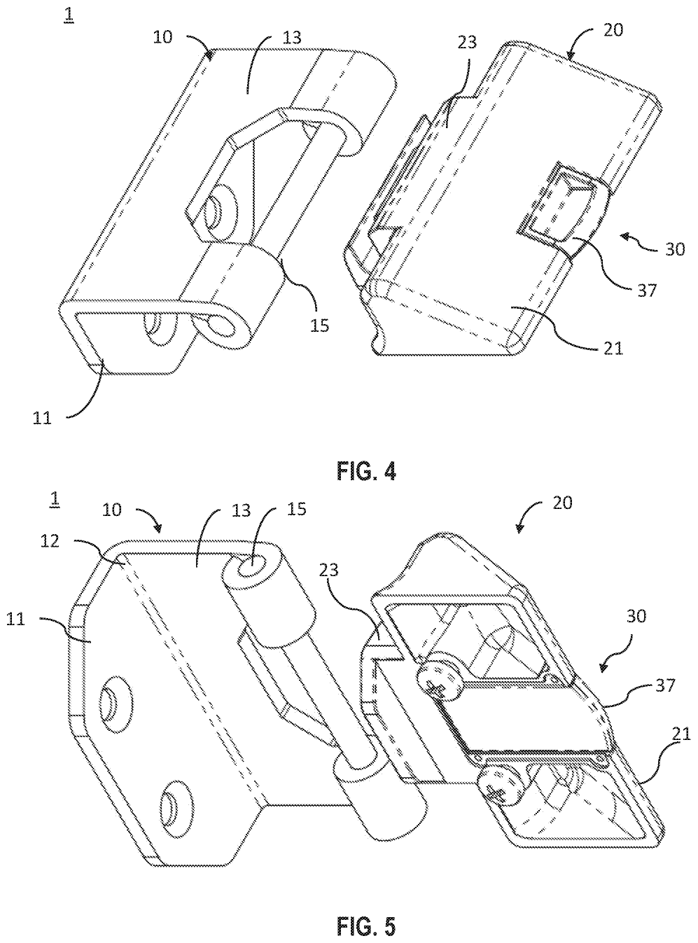

FIG. 4 shows a partially exploded perspective view of the click-in cabinet hinge 1 showing the exterior of the click-in cabinet hinge 1, according to an embodiment of the present invention. As shown in FIG. 4, the first hinge part 10 includes a first plate 11, a second plate 13, and a hinge pin 15. The first plate 11 secures the first hinge part 10 to the cabinet 5. It will be appreciated that the method of securing the first hinge part 10 to the cabinet 5 is not limiting. In an example, the first hinge part 10 is secured to the cabinet 5 with bolts or screws using mounting holes in the first plate 11, according to an embodiment.

In a non-limiting embodiment, the second plate 13 is attached to the first plate 11 edgewise, forming a first angle 12 in the range of 65 to 115 degrees inclusive. As a non-limiting example, the second plate 13 may be attached to the first plate 11 by welding or bonding. In another non-limiting example, the first plate 11 and the second plate 13 are integrally manufactured using an additive manufacturing process and may constitute one single piece. In yet another embodiment, the first hinge part 10 maybe milled and machined out of a single piece of material stock. It may be appreciated that the method of attaching or manufacturing the first plate 11 and the second plate 13 is not limiting and may be achieved through a plurality of methods and techniques.

FIG. 5 shows a partially exploded perspective view of the click-in cabinet hinge 1 showing the inside of the click-in cabinet hinge 1, according to an embodiment of the present invention. As it may be appreciated in the non-limiting embodiment shown in FIG. 5, the hinge pin 15 is connected to a side of second plate 13 that is opposite to the first plate 11. The ends of the hinge pin 15 may be secured to the second plate 13 by rolling strips of material protruding from the second plate 13 around the ends of the hinge pin 15, leaving a center portion of the hinge pin 15 exposed and separated away from an edge of the second plate 13. In other embodiments the hinge pin 15 is integrally manufactured with the second plate 13. The hinge pin 15 thereby is exposed in a recess formed between the two projections.

Returning now to FIG. 4, the second hinge part 20 includes a housing 21 and a hinge pin receiver 23 that includes a u-shape, the hinge pin receiver 23 connected to the housing 21. In an embodiment, the hinge pin receiver 23 is integrally manufactured to the housing 21. In other embodiments, the hinge pin receiver 23 may be welded, bonded, or fastened to the housing 21.

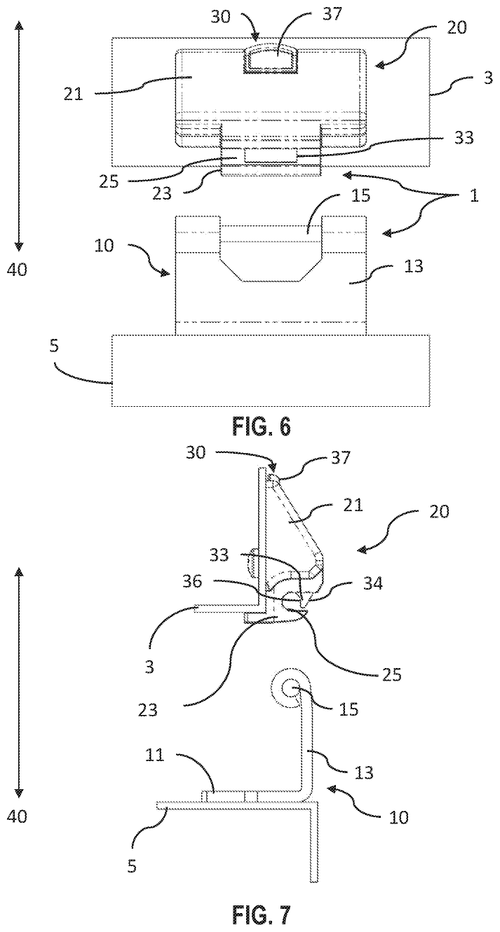

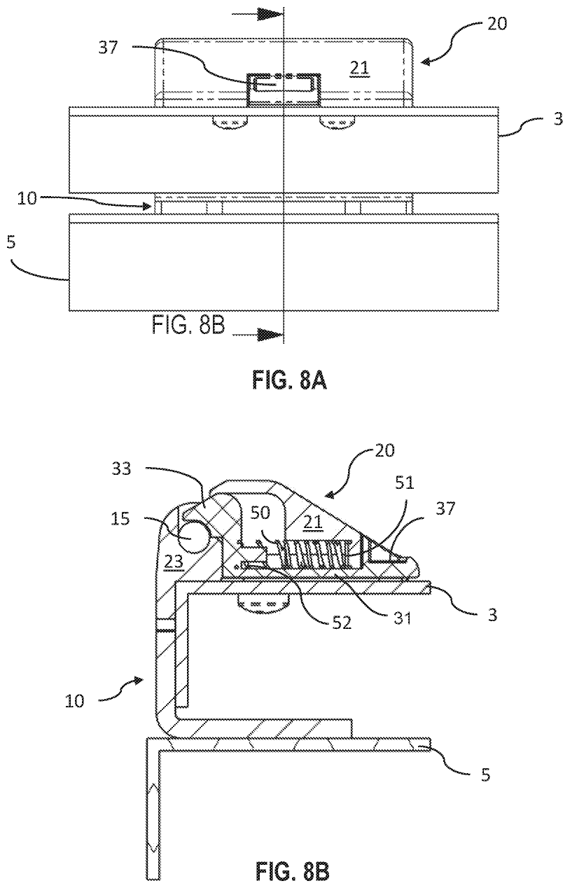

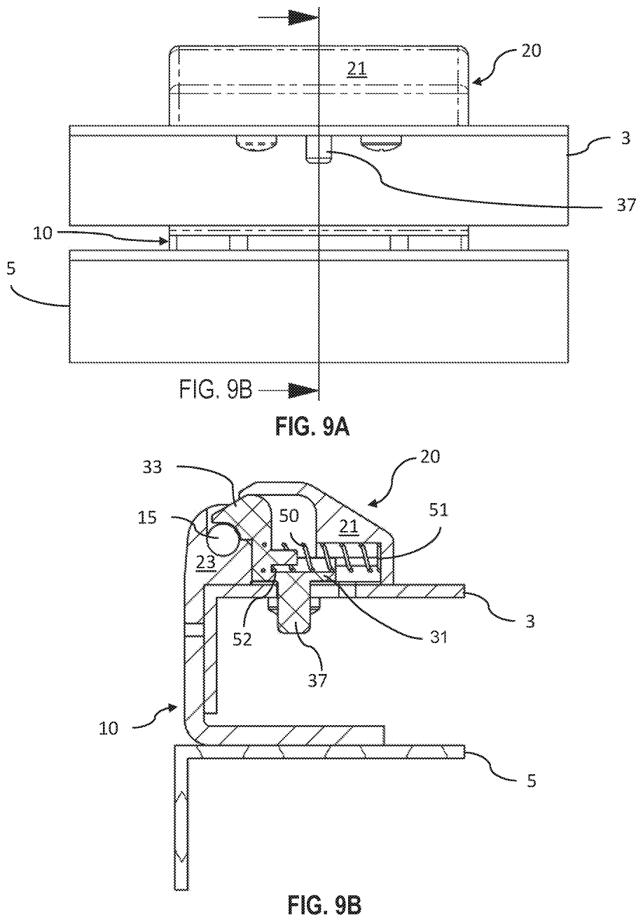

FIG. 6 shows a partially exploded plan view of the click-in cabinet hinge 1 installed on a door 3 and cabinet 5, when the door 3 is partially open, according to an embodiment of the present invention. The second hinge part 20 further includes a latch 30 with a body 31 (FIGS. 8B and 9B) and a catch 33, the catch 33 and body 31 may be integrally connected.

Turning to FIG. 7, a partially exploded side view of the click-in cabinet hinge 1 installed on a door 3 and next to the cabinet 5 where the door 3 is partially open is shown, according to an embodiment of the present invention. In an embodiment the catch 33 has an outer surface 34 and an inner surface 36.

In an embodiment, the body 31 of the latch 30 sits in sliding engagement inside the housing 21 allowing the catch 33 to slide along a longitudinal axis 40 which may be perpendicular to a longitudinal axis of the hinge pin 15, to allow the catch 33 to partially envelop a free portion of the hinge pin 15 when the hinge pin 15 is contained within a cross-sectional U-shape surface 25 of the hinge pin receiver 23. When the catch 33 is disposed across the hinge pin receiver 23 and can trap the hinge pin 15 there, the catch is in a locked position. When the catch 33 is retracted into the housing and the hinge pin 15 is free to leave the hinge pin receiver 23, the catch is in the unlocked position. In another embodiment, the U-shape surface 25 of the hinge pin receiver 23 and inner surface 36 of the hinge pin receiver 23 are in rotational contact with the hinge pin 15.

FIG. 8A is a side view of the click-in cabinet hinge 1 connecting a door 3 to a cabinet 5 when the door 3 is partially closed, according to an embodiment of the present invention. FIG. 8B is a cross-sectional side view of the click-in cabinet hinge 1 shown in FIG. 8A. In FIG. 8B, the click-in cabinet hinge 1 is shown in the closed configuration where the first hinge part 10 is secured to the cabinet 5 and to the second hinge part 20, and the second hinge part 20 is assembled to the closed cabinet door 3. In the closed configuration the door 3 is disposed between the housing 21 and the first plate 11 and the hinge pin receiver 23 opens/faces forward and away from the cabinet 5. This traps the door 3 between the cabinet 5 and the housing 21. In the closed configuration the hinge pin 15 is disposed farther forward of the cabinet 5 than is a front face of the cabinet door 3. This is in contrast to the open configuration shown in FIG. 3, where the cabinet door 3 is not closed. In both configurations a door side of the housing 21 rests on an outside-facing surface of the door 3.

As can be seen by referring to FIGS. 1 and 5, a part of the housing 21 fits into the recess when the click-in cabinet hinge 1 is in the closed configuration of FIG. 1. The shape of the recess and of the part of the housing 21 disposed in the recess cooperate to block movement of the second hinge part 20 toward the cabinet 5 and off the hinge pin 15, thereby trapping the door 3 between the housing 21 and the cabinet 5 when the click-in cabinet hinge 1 is in the closed configuration of FIG. 1.

The second hinge part 20 further includes a first biasing mechanism 50 with a first end 51 connected to the housing 21 and a second end 52 connected to the latch 30 thereby biasing the catch 33 over the hinge pin 15. It may be appreciated by those in the art that the type of biasing mechanism 50 is non-limiting. In an embodiment, the second end 52 of the biasing mechanism 50 may be positioned over a protruding part of the latch 30. In an embodiment, the biasing mechanism 50 is a coil spring. In an embodiment, the biasing mechanism 50 expands and contracts along a direction of movement of the catch 33 to exert the force that biases the catch into the locked position.

As shown in FIGS. 4 through 8B, the latch 30 further may include a tab 37 integrally connected to the body 31. In an embodiment, the tab 37 extends from the housing 21 on the outer surface of the door 3 thereby enabling a user to actuate the latch 30 from the exterior of the cabinet, for instance, while the door 3 is closed. In example embodiments, the (catch) body 31 is disposed forward of the door 3, at least partly recessed into the housing 21, and/or at least partly between the housing 21 and the door 3.

FIG. 9A is a side view of the click-in cabinet hinge 1 connecting a door 3 to a cabinet 5 when the door 3 is in the closed position, according to another embodiment of the present invention. FIG. 9B is a cross-sectional view of the click-in cabinet hinge 1 shown in FIG. 9A. In the non-limiting example shown in FIG. 9B, the tab 37 extends through a hole in the door 3 toward the cabinet 5 thereby allowing a user to actuate the latch 30 only from the inside of the cabinet, for instance, while the door 3 is open.

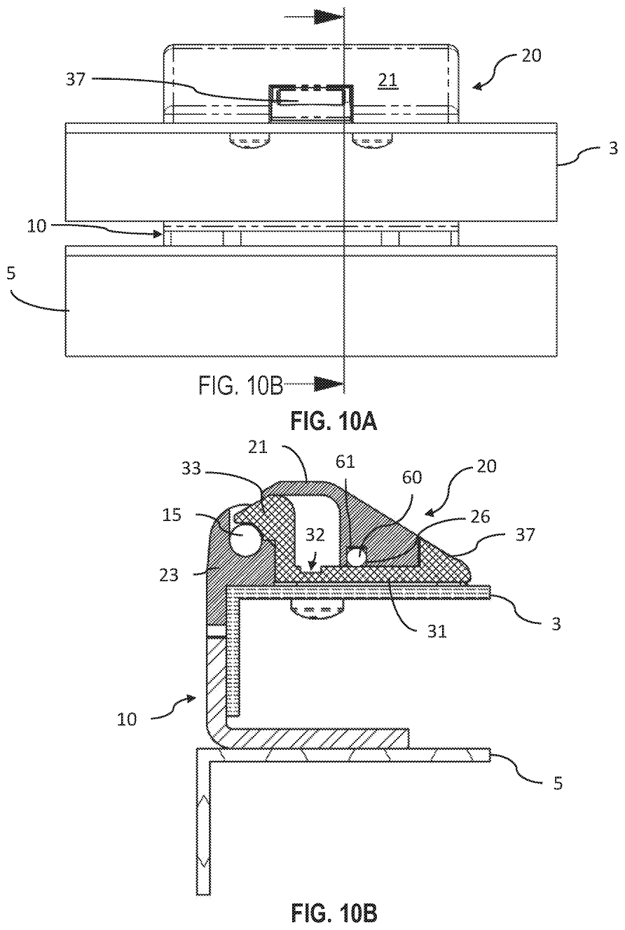

FIG. 10A is a side view of the click-in cabinet hinge 1 connecting a door 3 to a cabinet 5 when the door 3 is in the closed position, according to an embodiment of the present invention. FIG. 10B is a cross-sectional view off-set from the center of the click-in cabinet hinge 1 of FIG. 10A. As shown in FIG. 10B, the second hinge part 20 further includes a retention device 60 and a retention device biasing mechanism 61. According to one embodiment, the retention device 60 and the retention device biasing mechanism 61 are housed within a recess 26 of the housing 21. The latch 30 may include an opening 32. In an embodiment, the retention device 60 is biased by the retention device biasing mechanism 61 to engage the opening 32 when the latch 30 is moved along the longitudinal axis 40 away from the hinge pin 15 to a position (e.g. the unlocked position) where the latch 30 is prevented by the housing 21 from moving any further along the longitudinal axis 40. In another embodiment, the latch 30 may be moved along the longitudinal axis to an intermediate point where the catch 33 is not in contact with the hinge pin 15 and the retention device 60 does not engage the opening 32.

In yet another embodiment, the second hinge part 20 includes at least two retention devices 60 and at least two corresponding retention device biasing mechanisms 61. According to one embodiment, the retention devices 60 and the retention device biasing mechanisms 61 are housed within at least two corresponding recesses 26 of the housing 21. Correspondingly, the latch 30 may include at least one opening 32 to correspond to the at least one retention devices and retention device biasing mechanisms. In an embodiment, the retention devices 60 are biased by their corresponding retention device biasing mechanisms 61 to engage the corresponding openings 32 when the latch 30 is moved along the longitudinal axis 40 away from the hinge pin 15 to a position where the latch 30 is prevented by the housing 21 from moving any further along the longitudinal axis 40. In yet another embodiment, the latch 30 may be moved along the longitudinal axis to an intermediate point where the catch 33 is not in contact with the hinge pin 15 and the at least one retention device 60 does not engage the corresponding openings 32.

While the preferred embodiments of the present invention have been shown and described herein, it will be obvious that such embodiments are provided by way of example only. Numerous variations, changes and substitutions will occur to those of skill in the art without departing from the invention herein. Non-limiting examples include a component that is described above as being attached to one part of the apparatus may alternatively be attached to a different part of the apparatus in other embodiments. Parts described as being indirectly connected may be connected directly to each other, and vice versa. Component parts may be assembled from individual pieces or may be integrally formed as a single unit. Alternative types of connectors and alternative materials may be used. The apparatus may be used with other types of power tools. Accordingly, it is intended that the invention be limited only by the spirit and scope of the appended claims.

1. An apparatus, comprising:
a first hinge part comprising: a first plate; a second plate comprising two projections protruding transverse to the first plate and defining a recess therebetween; and a hinge pin exposed in the recess between the two projections; and
a second hinge part comprising: a housing comprising a u-shaped receiver configured to partly fit between the two projections and to receive the hinge pin therein and enable the housing to rotate about the hinge pin;
wherein in a closed configuration when the first hinge part is secured to a cabinet and to the second hinge part, and the second hinge part is assembled to a closed cabinet door, the closed cabinet door is disposed between the housing and the first plate and the u-shaped receiver opens forward and away from of the cabinet thereby trapping the closed cabinet door between the cabinet and the housing.

2. The apparatus of claim 1, further comprising:
a catch configured to extend across the u-shaped receiver and thereby trap the hinge pin therein when in a locked position, and configured to be withdrawn into an unlocked position the housing which release the hinge pin; and
a biasing mechanism configured to exert a force along a direction of travel of the catch that biases the catch into the locked position.

3. The apparatus of claim 2, further comprising a catch body disposed at least partly between the housing and the closed cabinet door and comprising: the catch; and a tab disposed forward of the closed cabinet door and which is movable to move the catch between the locked position and the unlocked position.

4. The apparatus of claim 2, further comprising:
a catch body comprising: the catch; and a tab that protrudes through a hole in the closed cabinet door toward the cabinet and which is movable to move the catch between the locked position and the unlocked position.

5. The apparatus of claim 2, wherein the biasing mechanism comprises a coil spring that expands and contracts along a direction of movement of the catch to exert the force.

6. The apparatus of claim 2, further comprising:
a catch body comprising the catch;
a housing recess in the housing and adjacent the catch body;
a resilient mechanism disposed in the housing recess;
a retention device which the resilient mechanism urges out of the housing recess and toward the catch body; and
a catch body recess in the catch body that aligns with and partly receives therein the retention device only when the catch is in the unlocked position.

7. The apparatus of claim 1, wherein in the closed configuration the second hinge part fits at least partly into the recess between the two projections and the first hinge part and the second hinge part cooperate to block movement of the second hinge part toward the cabinet and off the hinge pin.

8. An apparatus, comprising:
a first hinge part comprising two projections defining a recess therebetween; and a hinge pin exposed in the recess between the two projections; and
a second hinge part comprising: a housing defining a door side configured to be mounted to a cabinet door and a u-shaped receiver that faces away from the door side and that is configured to receive the hinge pin therein and enable the housing to rotate about the hinge pin;
wherein when in an assembled configuration the first hinge part is secured to a cabinet and to the second hinge part and the second hinge part is assembled to the cabinet door, the door side rests on an outside-facing surface of the cabinet door.

9. The apparatus of claim 8, further comprising:
a catch configured to move across the u-shaped receiver and parallel to the door side between: a locked position where the catch extends across the u-shaped receiver and thereby trap the hinge pin therein; and an unlocked position where the catch is withdrawn into the housing and thereby release the hinge pin; and
a biasing mechanism that exerts a force that is oriented parallel to a direction of movement of the catch and that urges the catch into the locked position.

10. The apparatus of claim 9, further comprising:
a catch body at least partly recessed into the housing and comprising: the catch; and a tab that is movable to move the catch between the locked position and the unlocked position.

11. The apparatus of claim 10, wherein when in the assembled configuration and when the cabinet door is closed the tab is accessible from outside of the cabinet.

12. The apparatus of claim 10, wherein when in the assembled configuration and when the cabinet door is closed the tab protrudes from the housing and through a hole in the cabinet door toward the cabinet.

13. The apparatus of claim 10, further comprising:
a housing recess in the housing and adjacent the catch body;
a catch body recess in the catch body that aligns with the housing recess only when the catch is in the unlocked position;
a spring disposed in the recess; and
a retention device which the resilient mechanism urges toward the catch body;
wherein then the catch is in the unlocked position the spring urges the retention device into the catch body recess, thereby preventing the catch body from moving into the locked position absent an application of external force.

14. The apparatus of claim 9, when in the assembled configuration and when the cabinet door is a closed cabinet door, the second hinge part fits at least partly into the recess and the first hinge part and the second hinge part cooperate to block movement of the second hinge part toward the closed cabinet door and off the hinge pin when the catch is in the unlocked position.

15. An apparatus, comprising:
a first hinge part comprising two projections defining a recess therebetween; and a hinge pin exposed in the recess between the two projections; and
a second hinge part comprising: a housing defining a door side configured to be mounted to a cabinet door and a u-shaped receiver that faces away from the door side and that is configured to receive the hinge pin therein and enable the housing to rotate about the hinge pin;
wherein in a closed configuration the first hinge part is assembled to a cabinet, the second hinge part is assembled to the first hinge part and to a closed cabinet door, and the hinge pin is disposed farther forward of the cabinet than a front face of the closed cabinet door.

16. The apparatus of claim 15, further comprising:
a catch configured to move across the u-shaped receiver and parallel to the door side between: a locked position where the catch extends across the u-shaped receiver and thereby trap the hinge pin therein; and an unlocked position where the catch is withdrawn into the housing and thereby release the hinge pin; and
a biasing mechanism that generates a force that is oriented parallel to a direction of movement of the catch and that urges the catch into the locked position.

17. The apparatus of claim 16, further comprising a catch body: that comprises the catch; that is at least partly disposed in the housing; that is disposed forward of the front face of the closed cabinet door; and that comprises a tab which is movable to move the catch between the locked position and the unlocked position.

18. The apparatus of claim 16, wherein the biasing mechanism comprises a coil spring that expands and contracts along the direction of movement of the catch to exert the force.

19. The apparatus of claim 17, further comprising:
a housing recess in the housing and adjacent the catch body;
a resilient mechanism disposed in the housing recess;
a retention device which the resilient mechanism urges out of the housing recess and toward the catch body; and
a catch body recess in the catch body that aligns with and partly receives therein the retention device only when the catch is in the unlocked position.

20. The apparatus of claim 15, wherein in the closed configuration the second hinge part fits at least partly into the recess between the two projections and the first hinge part and the second hinge part cooperate to block movement of the second hinge part toward the cabinet and off the hinge pin.
